(19) United States
(12) Patent Application Publication
(10) Pub. No.: US 2006/0062396 A1
(43) Pub. Date: Mar. 23, 2006

(54) Optical reproducing apparatus and method to transform external audio into multi-channel surround sound

(75) Inventor: Bok-keun Jin, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-si (KR)

(21) Appl. No.: 11/229,702

(22) Filed: Sep. 20, 2005

(30) Foreign Application Priority Data
Sep. 20, 2004 (KR) 2004-74946

(51) Int. Cl. H04R 5/00; H04R 5/02

(52) U.S. Cl. 381/19; 381/119; 381/18; 381/307

(57) ABSTRACT

An optical reproducing apparatus and method to transform external audio into multi-channel surround sound to provide a stereo effect. An optical disk drive detects a moving picture signal recorded on an optical disk. A digital signal processor digitalizes the detected moving picture signal. A decoder decompresses the digitalized moving picture signal. An audio processor converts an audio signal in the decompressed moving picture signal into a plurality of first sound sources corresponding to multi-channel surround sound having at least three channel sounds. An external-audio processor filters the external audio, inputted from a microphone, to convert the external audio into a plurality of second sound sources corresponding to the multi-channel surround sound. A mixer unit respectively mixes the plurality of first sound sources with the corresponding plurality of second sound sources. An audio output terminal unit outputs the plurality of mixed first and second sound sources through a plurality of speakers.

### CROSS-REFERENCE TO RELATED APPLICATIONS

This application claims benefit under 35 U.S.C. §119 from Korean Patent Application No. 2004-74946, filed on Sep. 20, 2004, the disclosure of which is incorporated herein by reference.

### BACKGROUND OF THE INVENTION

1. Field of the Invention

The present invention relates to an optical reproducing system and, more particularly, to an optical reproducing apparatus and method capable of transforming external audio that is inputted from a microphone, into multi-channel surround sound to provide a multi-channel stereo effect.

2. Description of the Related Art

A home theater system is used to allow a user to enjoy watching a DVD movie in a home, and have an experience similar to going to a cinema. To achieve this end, the home theater system includes an optical reproducing apparatus such as DVD player, a display appliance having a large screen, and a plurality of speakers supporting a multi-channel surround sound (for example, 5.1 channel).

The home theater system recently released provides an accompaniment function, as well as the above function. Specifically, the optical reproducing apparatus of the home theater system reproduces a plurality of music accompaniments, which are recorded on an optical disk (for example, DVD) in AC-3 format, in an audio corresponding to the multi-channel surround sound, such that a plurality of speakers output the audio reproduced corresponding to each channel sound. Accordingly, a user uses a function of a singing room (also called a karaoke room) with a microphone and the music accompaniment reproduced by the optical reproducing apparatus.

In the case of the optical reproducing apparatus employing the AC-3 format, the multi-channel surround sound includes channel sounds for each of front left, front right, center, subwoofer, rear left, and rear right.

In a conventional optical reproducing apparatus, however, the music accompaniment recorded on the optical disk is reproduced in the multi-channel surround sound, while the sound of the user inputted through the microphone is reproduced in two channel sounds only (i.e., front left and front right). In the case of utilizing the function of the music accompaniment by use of the home theater system employing a conventional optical reproducing apparatus, therefore, the user can enjoy the music accompaniment through the multi-channel surround sound, but the sound of the user inputted through the microphone is not provided to the user in the surround sound.

### SUMMARY OF THE INVENTION

Accordingly, it is an aspect of the present invention to provide an optical reproducing apparatus and method to transform external audio that is inputted from a microphone into multi-channel surround sound to provide a stereo effect.

The above aspect of the present invention is substantially realized by providing an optical reproducing apparatus to transform an external audio into multi-channel surround sound, having: an optical disk drive detecting a moving picture signal recorded on an optical disk; a digital signal processor digitalizing the detected moving picture signal; a decoder decompressing the digitalized moving picture signal; an audio processor converting an audio signal in the decompressed moving picture signal into a plurality of first sound sources corresponding to multi-channel surround sound having at least three channel sounds; an external-audio processor filtering the external audio, inputted from a microphone, to convert the external audio into a plurality of second sound sources corresponding to the multi-channel surround sound; a mixer unit respectively mixing the plurality of first sound sources with the corresponding plurality of second sound sources; and an audio output terminal unit outputting the plurality of mixed first and second sound sources through a plurality of speakers.

According to one aspect, the audio processor passes the decompressed audio signal through a plurality of first filters corresponding to the multi-channel surround sound having the at least three channel sounds to output the plurality of first sound sources.

According to one aspect, the external-audio processor passes the external audio through a plurality of second filters corresponding to the multi-channel surround sound having the at least three channel sounds to output the plurality of second sound sources.

According to one aspect, the optical reproducing apparatus additionally has an external-audio input terminal receiving the external audio from the microphone via a cable; and an external-audio analog/digital converter converting the input external audio into a digital signal.

According to one aspect, the optical reproducing apparatus additionally has an audio digital/analog converter converting the plurality of mixed first and second sound sources into respective analog signal signals to output the respective output signals to a corresponding plurality of audio,output terminals in the audio output terminal unit.

According to one aspect, the multi-channel surround sound includes six channels corresponding to a front right channel, a front left channel, a center channel, a subwoofer channel, a rear right channel, and a rear left channel.

According to one aspect, the optical reproducing apparatus additionally has a video processor for captioning a video signal contained in the decompressed moving picture signal; a video digital/analog converter converting the captioned video signal into an analog signal; and a video output terminal outputting the converted video signal to a display appliance.

In accordance with another aspect of the present invention, there is provided an optical reproducing method to transform an external audio into multi-channel surround sound, of the method having the operations: a) detecting a moving picture signal recorded on an optical disk; b) digitalizing the detected moving picture signal; c) decompressing the digitalized moving picture signal; d) converting an audio signal in the decompressed moving picture signal into a plurality of first sound sources corresponding to multi-channel surround sound having at least three channel sounds; e) filtering the external audio, inputted from a microphone, to convert the external audio into a plurality of second sound sources corresponding to the multi-channel surround sound; f) respectively mixing the plurality of first sound sources with the corresponding plurality of second sound sources; and g) outputting the plurality of mixed first and second sound sources through a plurality of speakers.

According to one aspect, operation d) includes passing the decompressed audio signal through a plurality of first filters corresponding to the multi-channel surround sound having the at least three channel sounds to output the plurality of first sound sources.

According to one aspect, operation e) includes passing the external audio through a plurality of second filters corresponding to the multi-channel surround sound having the at least three channel sounds to output the plurality of second sound sources.

According to one aspect, operation e) includes converting the input external audio into a digital signal to filter digitalized external audio.

According to one aspect, the optical reproducing method e additionally has, after operation f), converting the plurality of mixed first and second sound sources into respective analog signal signals to output it the respective analog signals to a plurality of audio output terminals.

According to one aspect, the optical reproducing method additionally has captioning a video signal in the decompressed moving picture signal; converting the captioned video signal into an analog signal; and outputting the converted video signal to a display appliance.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a block diagram schematically illustrating an optical reproducing apparatus with an adjustable size of a menu screen according to an embodiment of the present invention;

FIG. 2 is a block diagram illustrating a reproducing processor shown in FIG. 1;

FIG. 3 is a block diagram illustrating an external-audio processor shown in FIG. 1; and

FIG. 4 is a flowchart illustrating an optical reproducing method to transform an external audio signal into a multi-channel surround sound.

### DETAILED DESCRIPTION

Reference will now be made in detail to embodiments of the present invention, examples of which are illustrated in the accompanying drawings, wherein like reference numerals refer to the like elements throughout. The embodiments are described to explain the present invention by referring to the figures.

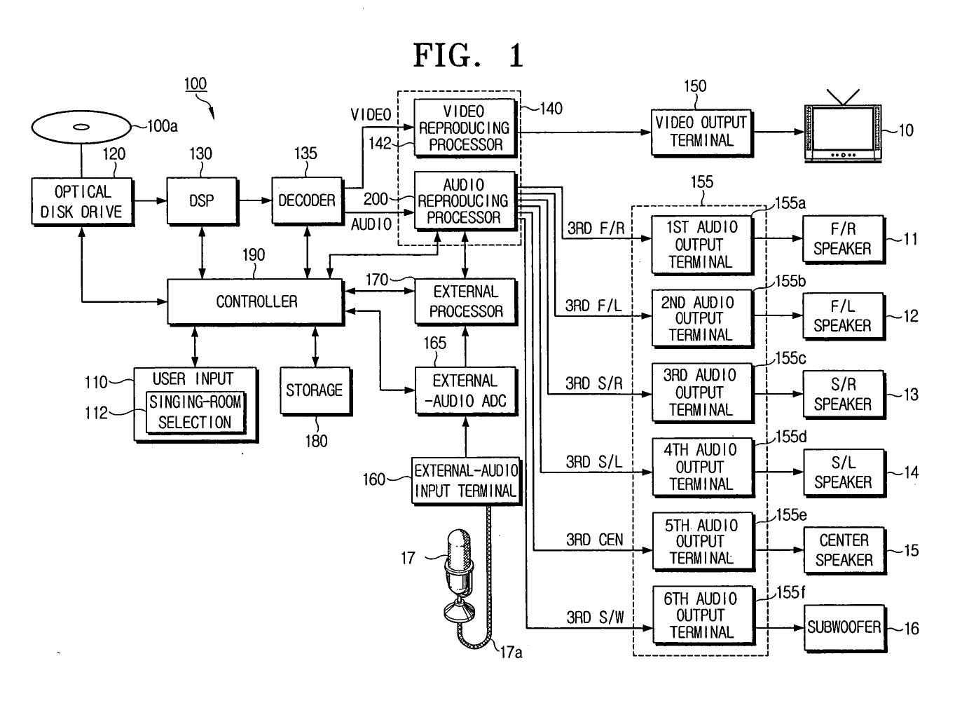

FIG. 1 is a block diagram schematically illustrating an optical reproducing apparatus with an adjustable size of a menu screen according to an embodiment of the present invention.

Referring to FIG. 1, an optical reproducing apparatus 100 includes a user input 110, an optical disk drive 120, a digital signal processor (hereinafter referred to as DSP) 130, a decoder 135, a reproducing processor 140, a video output terminal 150, an audio output terminal unit 155, an external-audio input terminal 160, an external-audio analog/digital converter (hereinafter referred to as ADC) 165, an external-audio processor 170, a storage 180, and a controller 190.

The optical reproducing apparatus 100 processes a moving picture signal (combined audio-video signal) recorded on an optical disk 100a as a reproducible signal to output the signal to a display appliance 10 such as TV. The optical reproducing apparatus 100 may be, for example, a DVD player, a DVDR (digital video disk recorder), a DVR (digital video disk recorder), or the like, and the optical disk 100a may be a DVD, a CD, or the like.

The user input 110 is a user interface outputting a command to the controller 180 to set or execute a function supported by the optical reproducing apparatus 100. To this end, the user input 110 includes input keys such as numeral keys, direction keys, an enter key, and the like.

According to one embodiment, the user input 110 has a singing-room mode selection 112 for selecting a singing room mode. The singing room mode is to reproduce music accompaniment, song words (lyrics) and scene screen recorded on the optical disk 110a, and simultaneously output the external audio, for example, a singing sound of the user that is inputted from a microphone 17. At that time, the optical reproducing apparatus 100 supports the multi-channel surround sound for the music accompaniment and the external audio, to allow the user to enjoy the multi-channel surround sound effect.

The singing room mode may be selected by a GUI (graphic user interface) screen, as well as the singing-room mode selection 112. The GUI screen is, for example, a menu screen, and may be realized by a video reproducing processor 142.

The optical disk drive 120 radiates light onto the optical disk 100a to detect the moving picture signal recorded on the optical disk 100a. Specifically, a pick-up portion (not shown) of the optical disk drive 120 radiates the light onto the optical disk 100a to detect an RF signal from the optical disk 100a. An RF amplifier (not shown) of the optical disk drive 120 amplifies the detected RF signal to convert it into an electric signal and output a servo signal for a servo. A servo (not shown) of the optical disk drive 120 receives the information required for the servo from the controller 190 and the RF amplifier to execute the servo.

The detected moving picture signal has an audio signal and a video signal. Also, when the audio signal is detected, the audio signal is divided into a right audio signal and a left audio signal.

The embodiment will now be described, by way of example, with reference to a case in which the optical disk 110a recorded with a plurality of lyrics and musical accompaniment related to the lyrics is loaded in the optical reproducing apparatus 100 to execute the function of the singing room. In this case, the video signal of the moving picture signal recorded on the optical disk 110a includes lyrics and the scene screen to execute the singing room, and the audio signal has a plurality of corresponding music accompaniment.

The DSP 130 digital-signal processes the electric signal converted by the optical disk drive 120. For example, the DSP 130 performs a process of demodulating and error correcting the electric signal to output the digitalized video signal and audio signal.

The decoder 135 decodes a video signal, a right audio signal, and a left audio signal inputted from the DSP 130 to decompress the video signal, the right audio signal, and the left audio signal. Preferably, the decoder 135 employs an algorithm corresponding to a compression format of the video signal, the right audio signal, and the left audio signal.

For example, in the case where the video signal is encoded in MPEG format, the decoder 135 decodes the video signal in the MPEG format. In addition, in the case where the right audio signal and the left audio signal are encoded in AC-3 (i.e., Dolby) format to support the multi-channel surround sound, the decoder 135 decodes the right audio signal and the left audio signal in the AC-3 format.

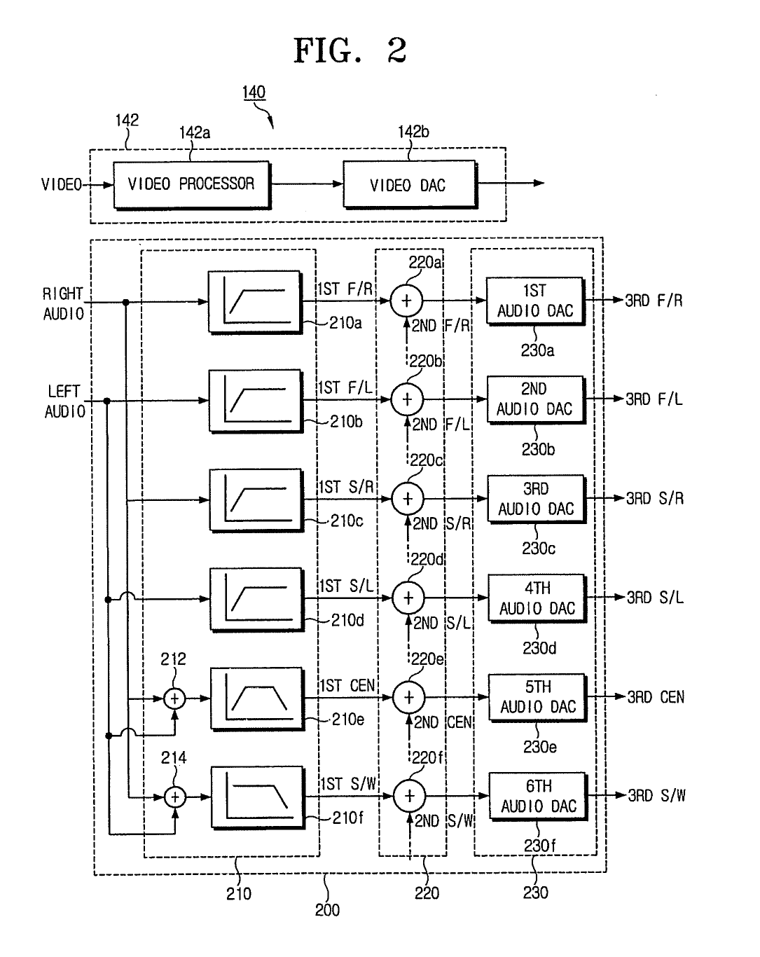

The reproducing processor 140 processes the decoded video signal, the decoded right audio signal, and the decoded left audio signal outputted from the decoder 135 as signals that can be recognized by the display appliance 10. To this end, the reproducing processor 140 includes a video reproducing processor 142 and an audio reproducing processor 200, as shown in FIG. 2.

Referring to FIG. 2, the video reproducing processor 142 includes a video processor 142a and a video digital/analog converter (hereinafter referred to as DAC) 142b.

The video processor 142a processes the decoded video signal as a signal that can be recognized by the display appliance 10. For example, the video processor 142a processes the decoded video signal to output the scene screen and the lyrics to be displayed on the display appliance 10 when executing the function of the singing room.

The video DAC 142b converts the video signal outputted from the video processor 142a into an analog signal to output the signal to the video output terminal 150.

The video output terminal 150 transmits the analog video signal to the display appliance 10. As a result, the display appliance 10 displays the scene screen, the lyrics, and the like. According to one embodiment, the display appliance is connected to the video output terminal 150 via a transmission cable (not shown). In a case where the display appliance 10 is in wireless communication with the optical reproducing apparatus 100, the video signal outputted from the video DAC 142b may be wirelessly transmitted to the display appliance 10.

The audio reproducing processor 200 includes an audio processor 210, a mixer unit 220, and an audio DAC unit 230.

The audio processor 210 converts the decoded right and left audio signals into a plurality of first sound sources corresponding to the multi-channel surround sound. Specifically, the audio processor 210 divides the decoded right and left audio signals into a signal corresponding to each speaker to provide a Dolby surround sound.

The multi-channel surround sound is at least 3 channel surround sound, such as 4.1 channel surround sound, 5.1 channel surround sound, 7.1 channel surround sound, or the like. For exemplary purposes, the 5.1 channel surround sound will be described. The 5.1 channel surround sound includes six channel sounds, one each for front left (referred to as “F/L”), front right (referred to as “F/R”), surround left (referred to as “S/L”), surround right (referred to as “S/R”), center (referred to as “CEN”), and subwoofer (referred to as “SAN”).

As an example, in a case where the left and right audio signals are decoded in the AC-3 format or DTS format and the optical reproducing apparatus 100 supports the 5.1 channel surround sound, operation of the audio processor 210 will now be described in detail.

The audio processor 210 passes the left and right audio signals through six filters 210a, 210b, 210c, 210d, 210e, and 210f to output a plurality of first sound sources.

The first F/R filter 210a is a high pass filter filtering only signals above a first frequency among right audio signals, to generate a first F/R signal.

Similarly, the first F/L filter 210b is a high pass filter for filtering only signals above the first frequency among left audio signals, to generate a first F/L signal.

The first S/R filter 210c is a high pass filter filtering only signals above the first frequency among right audio signals. The audio processor 210 adds reverberation to the filtered audio signal by use of a delay buffer (not shown) to generate a first S/R signal. Added reverberation provides the audio signal, i.e., music accompaniment, detected by the optical disk 110a with a reverberating effect, such as echo.

The first S/L filter 210d is a high pass filter filtering only signals above the first frequency among left audio signals. The audio processor 210 adds reverberation to the filtered audio signal by use of a delay buffer (not shown) to generate a first S/L signal.

A first pre-mixer 212 mixes the right audio signal with the left audio signal to output the mixed signal to a first CEN filter 210e. The first CEN filter 210e is a band pass filter filtering the mixed right and left audio signals to generate a first CEN signal.

A second pre-mixer 214 mixes the right audio signal with the left audio signal to output the mixed signal to a first SAN filter 210f. The first SAN filter 210f is a low pass filter filtering a signal of below a second frequency among the mixed right and left audio signals, to generate a first S/W signal.

The plurality of first sound sources includes the first F/R signal, the first F/L signal, the first S/R signal, the first S/L signal, the first CEN signal, and the first SAN signal, which are generated by the audio processor 210.

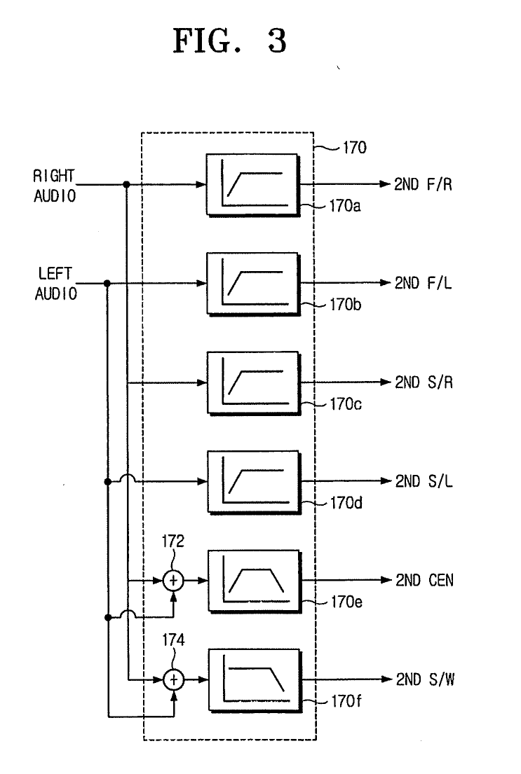

The mixer unit 220 mixes the plurality of first sound sources with a plurality of second sound sources generated by the external-audio processor 170. To this end, the mixer unit 220 has first through sixth mixers 220a, 220b, 220c, 220d, 220f and 220e. After the process of processing the external audio is described in detail with reference to FIGS. 1 and 3, the operation of the mixer unit 220 will be described in detail.

FIG. 3 is a block diagram illustrating the external-audio processor 170 shown in FIG. 1.

Referring to FIGS. 1 and 3, the external-audio input terminal 160 receives the external audio outputted from the microphone 17 through the cable 17a. The optical reproducing apparatus 100 may be in wireless communication with the microphone 17 to transmit the external audio, but the present embodiment is described with respect to the wired communication using the cable 17a.

The external-audio ADC 165 converts the external audio inputted through the external-audio input terminal 160 into a digital external audio signal.

The external-audio processor 170 filters the external audio that is converted into the digital signal, to convert the external audio inputted from the microphone to a plurality of second sound sources corresponding to multi-channel surround sound.

Specifically, according to one embodiment, the external-audio processor 170 conventionally divides the external audio, which is converted into the digital signal, into a left external audio and a right external audio. According to another embodiment, the external audio is conventionally divided into a left external audio and a right external audio prior to receipt by the external-audio processor 170. For example, the external-audio ADC 165 may conventionally divide the external audio. After the external audio has been divided, the external-audio processor 170 processes the divided left and right external audios into signals corresponding to each speaker, to provide a Dolby (5.1) surround sound.

For example, in the case where the optical reproducing apparatus 100 supports the 5.1 channel surround sound and any one of the AC-3 format and the DTS format, the operation of the external-audio processor 170 will now be described in detail.

A second F/R filter 170a is a high pass filter filtering only signals above a third frequency among right audio signals, to generate a second F/R signal.

A second F/L filter 170b is a high pass filter filtering only signals above the third frequency among left audio signals, to generate a second F/L signal.

A second S/R filter 170c is a high pass filter filtering only signals above the third frequency among right audio signals. The audio processor 210 adds reverberation to the filtered audio signal by use of a delay buffer (not shown) to generate a second S/R signal.

A second S/L filter 170d is a high pass filter filtering only signals above the third frequency among left audio signals. The audio processor 210 adds reverberation to the filtered audio signal by use of a delay buffer (not shown) to generate a second S/L signal.

The third pre-mixer 172 mixes the right audio signal with the left audio signal to output the mixed signal to a second CEN filter 170e. The second CEN filter 170e is a band pass filter filtering the mixed right and left audio signals to generate a second CEN signal.

The fourth pre-mixer 174 mixes the right audio signal with the left audio signal to output the mixed signal to a second SAN filter 170f. The second S/W filter 170f is a low pass filter filtering signals below a fourth frequency among the mixed right and left audio signals, to generate a second SAN signal.

The plurality of second sound sources comprises the second F/R signal, the second F/L signal, the second S/R signal, the second S/L signal, the second CEN signal, and the second SAN signal, which are generated by the external-audio processor 170.

Referring again to FIG. 2, the first mixer 220a mixes the first F/R signal with the second F/R signal to output a third F/R signal, and the second mixer 220b mixes the first F/L signal with the second F/L signal to output a third F/L signal.

The third mixer 220c mixes the first S/R signal with the second S/R signal to output a third S/R signal, and the fourth mixer 220d mixes the first S/L signal with the second S/L signal to output a third S/L signal.

The fifth mixer 220e mixes the first CEN signal with the second CEN signal to output a third CEN signal, and the sixth mixer 220f mixes the first S/N signal with the second SAN signal to output a third SAN signal.

The audio DAC unit 230 converts a plurality of mixed first and second sound sources (the respective third sound sources) outputted from the mixer unit 220 into analog signals to output it to a plurality of audio output terminals 155(a-f).

To this end, the audio DAC unit 230 includes first through sixth audio DACs 230a to 230f. The first through sixth audio DACs 230a to 230f respectively converts the third F/R signal, third F/L signal, third S/R signal, third S/L signal, third CEN signal, and the third SAN signal, which are generated by the mixing, into an analog signal.

The audio output terminal unit 155 includes first through sixth audio terminals 155a, 155b, 155c, 155d, 155e and 155f. The first through sixth audio terminals 155a, 155b, 155c, 155d, 155e and 155f respectively outputs the third F/R signal, third F/L signal, third S/R signal, third S/L signal, third CEN signal, and the third SAN signal, which are converted into the analog signal, to the F/R speaker 11, the F/L speaker 12, the S/R speaker 13, the S/L speaker 14, the center speaker 15, and the subwoofer speaker 16.

The storage 180 includes a ROM storing a control program to operate the optical reproducing apparatus 100, and a RAM to temporarily store data generated during the operation of the optical reproducing apparatus 100.

The controller 190 controls the operation of the optical reproducing apparatus 100 according to the signal outputted from the user input 110 or a remote controller (not shown), and the stored control program.

If the singing room mode is selected by the singing-room mode selection 112, and the user input 110 requests the reproduction of the optical disk 110a, the controller 190 controls the optical disk drive 120 to detect the moving picture signal recorded on the optical disk 110a. Also, the controller 190 controls the reproducing processor 140 to reproduce and output the detected moving picture signal, and thus output the detected moving picture signal to the display appliance 10 and the speakers 11 through 16.

In particular, when the optical reproducing apparatus 100 receives the external audio from the microphone 17 in the singing room mode, the controller controls the external-audio processor 170 to generate the input external audio as a plurality of signals corresponding to the multi-channel surround sound, and controls the audio reproducing processor 200 to mix the processed external audio with the reproduced audio signal and convert the mixed signal into the analog signal sent to the audio output terminal unit 155. As a result, in addition to the audio signal recorded on the optical disk 110a, the external audio inputted from the microphone 17 is outputted to a plurality of speakers 11 through 16.

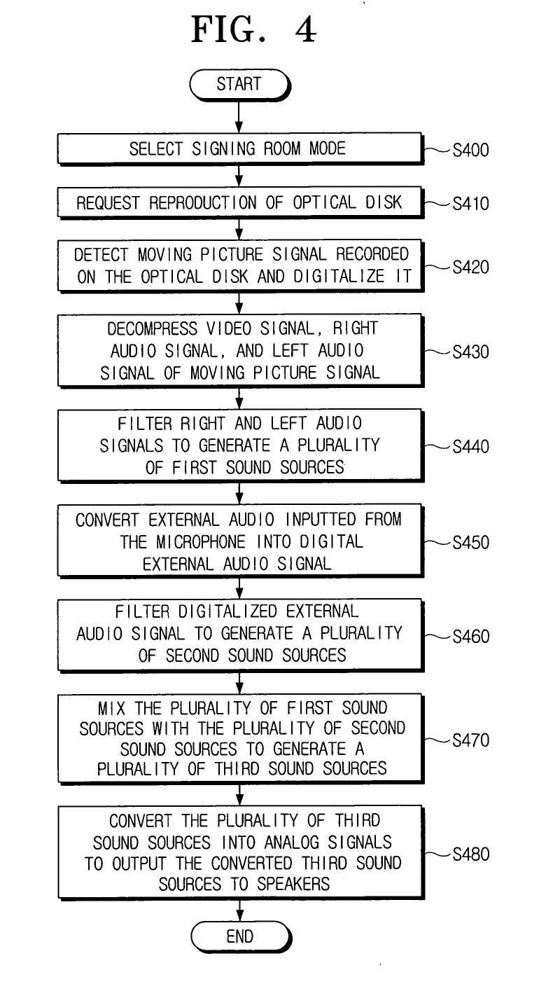

An embodiment of the present invention will now be described in detail with reference to FIG. 4.

FIG. 4 is a flowchart illustrating an optical reproducing method to transform the external audio into the multi-channel surround sound.

Referring to FIGS. 1 through 4, after the signing room mode is selected by the singing-room mode selection 112, if the user input 110 requests the reproduction of the optical disk 110a, the controller 190 controls the optical disk drive 120 and the DSP 130 to detect the moving picture signal recorded on the optical disk 110a and then digitalize the moving picture signal (operations S400, S410, S420). The digitalized moving picture signal contains the video signal, the right audio signal, and the left audio signal.

The controller 190 then controls the decoder 135 to decode and decompress the digitalized moving picture signal, i.e., the video signal, the right audio signal, and the left audio signal (operation S430).

The controller 190 controls the video reproducing processor 142 to process the decoded video signal as a signal that can be recognized by the display appliance 10, and also controls the audio reproducing processor 200 to filter the decoded right and left audio signals and thereby to generate the plurality of first sound sources (operation S440).

Specifically, the controller 190 controls the audio processor 210 to pass the decoded right audio signal through the first F/R filter 210a, the first S/R filter 210c, the first pre-mixer 212, the first CEN filter 210e, the second pre-mixer 214, and the first SAN filter 210f, and also pass the decoded left audio signal through the first F/L filter 210b, the first S/L filter 210d, the first pre-mixer 212, the first CEN filter 210e, the second pre-mixer 214, and the first SAN filter 210f, thereby generating the first F/R signal, the first F/L signal, the first S/R signal, the first S/L signal, the first CEN signal, and the first SAN signal.

The controller 190 controls the external-audio ADC 165 to convert the external audio inputted from the microphone 17 into the digital external audio signal (operation S450). Also, the controller 190 controls the external-audio processor 170 to filter the digitalized external audio signal, and thereby generate the plurality of second sound sources corresponding to the multi-channel surround sound (operation S460).

Specifically, the controller 190 controls the external-audio processor 170 to pass the digitalized right external audio signal through the second F/R filter 170a, the second S/R filter 170c, the third pre-mixer 172, the second CEN filter 170e, the fourth pre-mixer 174, and the second S/W filter 170f, and also pass the digitalized left external audio signal through the second F/L filter 170b, the second S/L filter 170d, the third pre-mixer 172, the second CEN filter 170e, the fourth pre-mixer 174, and the second SAN filter 170f, thereby generating the second F/R signal, the second F/L signal, the second S/R signal, the second S/L signal, the second CEN signal, and the second SAN signal.

Then, the controller 190 controls the first through sixth mixers 220a, 220b, 220c, 220d, 220e, and 220f to mix the plurality of first sound sources generated in operation S440 with the plurality of second sound sources generated in operation S460, and thereby generate the plurality of third sound sources (operation S470).

And, the controller 190 controls the first through sixth audio DACs 230a to 230f to convert the plurality of third sound sources into analog signals and output the converted third sound sources to the speakers 11 through 16 through the first through sixth audio output terminals 155a, 155b, 155c, 155d, 155e, and 155f (operation S480).

As a result, the F/R speaker 11 outputs the third F/R signal, the F/L speaker 12 outputs the third F/L signal, the S/R speaker 13 outputs the third S/R signal, the S/L speaker 14 outputs the third S/L signal, the center speaker 15 outputs the third CEN signal, and the subwoofer speaker 16 outputs the third SAN signal. In other words, the music accompaniment recorded on the optical disk 100a (i.e., the right audio signal and the left audio signal), and the right external audio and the left external audio inputted through the microphone 17 are realized into the multi-channel surround sound, thereby outputting through the speakers 11 through 16.

In addition, the lyrics and the scene screen recorded on the optical disk 100a (i.e., video signals) are signal processed to be displayed on the display appliance 10 through the video output terminal 150.

With the above description, according to the optical reproducing apparatus and method to transform the external audio that is inputted from a microphone into the multi-channel surround sound, the external audio inputted from the microphone is realized into the multi-channel surround sound, such as a 5.1 channel stream, and is then mixed with the music accompaniment recorded on the optical disk, thereby providing the multi-channel surround sound effect using a simple circuit.

Thus, a problem of sound deterioration is solved by digitalizing the external audio into the multi-channel surround sound. The present invention can provide the function of the singing room by adding the reverberation to the external audio and the musical accompaniment recorded on the optical disk.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical reproducing apparatus to transform an external audio into multi-channel surround sound, comprising:
an optical disk drive detecting a moving picture signal recorded on an optical disk;
a digital signal processor digitalizing the detected moving picture signal;
a decoder decompressing the digitalized moving picture signal;
an audio processor converting an audio signal in the decompressed moving picture signal into a plurality of first sound sources corresponding to multi-channel surround sound having at least three channel sounds;
an external-audio processor filtering the external audio, inputted from a microphone, to convert the external audio into a plurality of second sound sources corresponding to the multi-channel surround sound;
a mixer unit respectively mixing the plurality of first sound sources with the corresponding plurality of second sound sources; and
an audio output terminal unit outputting the plurality of mixed first and second sound sources through a plurality of speakers.

2. The optical reproducing apparatus as claimed in claim 1, wherein the audio processor passes the decompressed audio signal through a plurality of first filters corresponding to the multi-channel surround sound having the at least three channel sounds, to output the plurality of first sound sources.

3. The optical reproducing apparatus as claimed in claim 1, wherein the external-audio processor passes the external audio through a plurality of second filters corresponding to the multi-channel surround sound having the at least three channel sounds, to output the plurality of second sound sources.

4. The optical reproducing apparatus as claimed in claim 1, further comprising:
an external-audio input terminal receiving the external audio from the microphone via a cable; and
an external-audio analog/digital converter converting the input external audio into a digital signal.

5. The optical reproducing apparatus as claimed in claim 1, further comprising an audio digital/analog converter converting the plurality of mixed first and second sound sources into respective analog signals to output the respective output signals to a corresponding plurality of audio output terminals in the audio output terminal unit.

6. The optical reproducing apparatus as claimed in claim 1, wherein the multi-channel surround sound includes six channels corresponding to a front right channel, a front left channel, a center channel, a subwoofer channel, a rear right channel, and a rear left channel.

7. The optical reproducing apparatus as claimed in claim 1, further comprising:
a video processor captioning a video signal contained in the decompressed moving picture signal;
a video digital/analog converter converting the captioned video signal into an analog signal; and
a video output terminal outputting the converted video signal to a display appliance.

8. An optical reproducing method to transform an external audio into multi-channel surround sound, comprising the operations:
a) detecting a moving picture signal recorded on an optical disk;
b) digitalizing the detected moving picture signal;
c) decompressing the digitalized moving picture signal;
d) converting an audio signal in the decompressed moving picture signal into a plurality of first sound sources corresponding to multi-channel surround sound having at least three channel sounds;
e) filtering the external audio, inputted from a microphone, to convert the external audio into a plurality of second sound sources corresponding to the multi-channel surround sound;
f) respectively mixing the plurality of first sound sources with the corresponding plurality of second sound sources; and
g) outputting the plurality of mixed first and second sound sources through a plurality of speakers.

9. The optical reproducing method as claimed in claim 8, wherein operation d) further comprises:
passing the decompressed audio signal through a plurality of first filters corresponding to the multi-channel surround sound having the at least three channel sounds, to output the plurality of first sound sources.

10. The optical reproducing method as claimed in claim 8, wherein operation e) further comprises:
passing the external audio through a plurality of second filters corresponding to the multi-channel surround sound having the at least three channel sounds, to output the plurality of second sound sources.

11. The optical reproducing method as claimed in claim 8, where operation e) further comprises converting the input external audio into a digital signal to filter digitalized external audio.

12. The optical reproducing method as claimed in claim 8, further comprising:
after operation f), converting the plurality of mixed first and second sound sources into respective analog signals to output the respective analog signals to a plurality of audio output terminals.

13. The optical reproducing method as claimed in claim 8, wherein the multi-channel surround sound includes six channels corresponding to a front right channel, a front left channel, a center channel, a subwoofer channel, a rear right channel, and a rear left channel.

14. The optical reproducing method as claimed in claim 8, further comprising:
captioning a video signal in the decompressed moving picture signal;
converting the captioned video signal into an analog signal; and
outputting the converted video signal to a display appliance.

15. An optical reproducing apparatus to transform an external audio signal into multi-channel surround sound having a plurality of least three channels, comprising:
a user input with a plurality of selectable modes, including a singing room mode;
an optical disk drive processing a combined signal recorded on an optical disk, the combined signal having both audio and video signals;
a digital signal processor digitalizing the combined signal;
a decoder decompressing the digitalized signal;
an external-audio processor converting the external audio signal, inputted from a microphone, into a plurality of external sound sources corresponding to the plurality of channels;
a reproducing processor
processing the video signal in the decompressed signal and converting the processed video signal to an analog video signal,
converting the audio signal in the decompressed signal into a plurality of first sound sources corresponding to the plurality of channels, and
respectively mixing the plurality of first sound sources with the corresponding plurality of external sound sources;
an audio output terminal unit outputting the plurality of mixed first and external sound sources through a plurality of speakers corresponding to the plurality of channels; and
a video output terminal outputting the analog video signal from the reproducing processor to a display appliance.

16. The optical reproducing apparatus according to claim 15, further comprising:
a storage storing a control program; and
a controller controlling the optical reproducing apparatus in accordance with the control program and a selected option from the user input.

17. The optical reproducing apparatus according to claim 15, wherein the reproducing processor comprises:
a video reproducing processor having
a video processor processing the video signal in the decompressed signal, and
a video digital/analog converter converting the processed video signal to the analog video signal; and
an audio reproducing processor having
an audio processor filtering the audio signal in the decompressed signal into the plurality of first sound sources corresponding to the plurality of channels,
a mixer unit respectively mixing the plurality of first sound sources with the corresponding plurality of external sound sources, and
an audio digital/analog converter converting the mixed plurality of sound sources to an analog mixed plurality of sound sources corresponding to the plurality of channels.

18. The optical reproducing apparatus according to claim 15, wherein the external-audio processor converts the external audio by filtering the external audio into the plurality of external sound sources corresponding to the plurality of channels.

19. An optical reproducing method to transform an external audio signal into multi-channel surround sound having a plurality of least three channels, the method comprising:
selecting a singing room mode on an optical reproducing apparatus;
digitalizing a combined signal recorded on an optical disk, the combined signal having both audio and video signals;
decompressing the digitalized signal into a video signal, a right audio signal, and a left audio signal;
filtering the left and right audio signals to generate a plurality of first sound sources corresponding to the plurality of channels;
digitalizing the external audio signal, inputted from a microphone, into a digital external audio signal;
filtering the digital external audio signal to generate a plurality of second sound sources corresponding to the plurality of channels;
respectively mixing the plurality of first sound sources and the plurality of second sound sources to generate a plurality of third sound sources corresponding to the plurality of channels;
respectively converting the plurality of third sound sources into plurality of analog signals corresponding to the plurality of channels, and outputting the plurality of analog signals to a plurality of speakers corresponding to the plurality of channels.

20. An optical reproducing method to transform an external audio signal into multi-channel surround sound having a plurality of least three channels, the method comprising:
digitalizing and decompressing a signal recorded on an optical disk into at least a right audio signal, and a left audio signal;
filtering the left and right audio signals to generate a plurality of first sound sources corresponding to the plurality of channels;
digitalizing the external audio signal, inputted from a microphone, into a digital external audio signal;
filtering the digital external audio signal to generate a plurality of second sound sources corresponding to the plurality of channels;
respectively mixing the plurality of first sound sources and the plurality of second sound sources to generate a plurality of third sound sources to be output to a plurality of speakers corresponding to the plurality of channels.

21. An optical reproducing method, comprising:
producing at least three sound signals from an optical disk recording a moving picture and sound;
combining the at least three sound signals with an external sound signal to produce at least three combined sound signals; and
respectively outputting the at least three combined sound signals as audio sound via at least three speakers.
